(19) United States
(12) Patent Application Publication
(10) Pub. No.: US 2001/0030390 A1
(43) Pub. Date: Oct. 18, 2001

(54) Hydraulically damping engine bearing

(75) Inventors: Freddy Vermaerke, Troisdorf (DE); Heinrich Meyer, Konigswinter (DE)

Correspondence Address: Thomas C. Pontani, Esq., Cohen, Pontani, Lieberman & Pavane, Suite 1210, 551 Fifth Avenue, New York, NY, 10176, US

(73) Assignee: Mannesmann Sachs AG

(21) Appl. No.: 09/827,567

(22) Filed: Apr. 5, 2001

(30) Foreign Application Priority Data
Apr. 12, 2000 (DE) 100 18 185.6

(51) Int. Cl. F16M 7/00; F16F 13/00; F16F 15/00

(52) U.S. Cl. 267/140.15

(57) ABSTRACT

A hydraulically damping engine bearing includes fluid-filled chambers defined at least partially by an elastic wall. A dividing wall with a diaphragm divides the chambers. The diaphragm is deflectable in a limited manner and defines an intermediate space with the dividing wall. At least one channel is arranged through the dividing wall for connecting the chambers. A bearing characteristic is adjustable by changing the rigidity of the diaphragm such that the diaphragm works against a gas volume enclosed in the intermediate space when the diaphragm as a low rigidity and the diaphragm rests at least partially at a stop on the dividing wall when the diaphragm as a high rigidity. A switch is arranged for opening a flow connection to the atmosphere or a pressure accumulator for aerating the intermediate space. A check valve is arranged for deaeration of the intermediate space in response to the pulling and pushing movements of the engine bearing so that the intermediate space can be pumped empty by the pumping work of the elastic walls via the check valve.

### BACKGROUND OF THE INVENTION

1. Field of the Invention

The present invention relates to a hydraulically damping engine bearing with fluid-filled chambers defined at least partially by elastic walls and divided by a dividing wall having a diaphragm which is deflectable in a limited manner and at least one channel connecting the chambers, wherein a characteristic of the bearing is adjustable by changing a rigidity of a flexible part of the diaphragm arranged in one of the chambers such that the flexible part works against a gas volume that is enclosed in an intermediate space at a low rigidity and the flexible part rests at least partially at a stop at a high rigidity. The hydraulically damping engine bearing further includes a switch connected for opening a flow connection to the atmosphere or to a pressure accumulator for aerating the intermediate space and a valve for deaerating the intermediate space via the flow connection. The valve includes a non-return or check valve in the area of the outer wall and is acted upon by the pulling and pushing movements of the engine bearing so that the intermediate space is pumped empty by the pumping work of the elastic walls via the check valve.

2. Description of the Related Art

A hydraulically damping engine bearing having a dividing wall arranged between two chambers is known, for example, from DE 42 38 752 C1 and corresponding U.S. Pat. No. 5,386,977. One of the chambers has an elastic diaphragm extending annularly at the outer wall. An intermediate space is formed between the elastic diaphragm and the outer wall and a check valve is connected to the intermediate space for achieving a high rigidity of the engine bearing. The intermediate space is used to influence the spring characteristics and may be deaerated without external means in the event that the bearing is connected in a hard manner. During operation of this bearing, the pulling and pushing movements of the bearing create a pumping action so that the internal pressure acting on the flexible wall empties the intermediate space via the check valve until the flexible wall contacts the rigid structural component part. A switch may then be opened to aerate the intermediate space so that the intermediate space is connected to the atmosphere and the flexible wall is brought into its basic position. Accordingly this bearing uses a simple, reliable control principle in which the elastic walls pump out the intermediate space via the check valve through their pump work, while gas flows into the intermediate space from the atmosphere or from a pressure accumulator when the switch is actuated.

However, the known bearing uses a laterally arranged flexible wall to define the intermediate space which requires a relatively large overall height of the bearing.

### SUMMARY OF THE INVENTION

It is the object of the invention to provide a hydraulically damping engine bearing which is selectively controlled in a hard or soft manner that avoids a complex construction, achieves a simple and dependable control in the immediate vicinity of the engine bearing without long line paths, and includes a short and compact unit.

The object is met according to the present invention by a hydraulically damping engine bearing with fluid-filled chambers defined at least partially by elastic walls and divided by a dividing wall having a diaphragm which is deflectable in a limited manner and at least one channel connecting the chambers, wherein the diaphragm which can be deflected in a defined manner is flexible in a region of the dividing wall needed for clamping in the diaphragm such that an intermediate space needed for the gas volume is defined between the diaphragm and the dividing wall.

In this respect, the switchable flexibility of the diaphragm is formed horizontally. Accordingly, the diaphragm used for adjusting a bearing characteristic is also a decoupling diaphragm, so that a compact hydraulically damping engine bearing is achieved.

According to the present invention, the flexible diaphragm extends in an annular shape about a longitudinal axis of the engine bearing. Alternatively, the diaphragm may be constructed circularly.

According to a further embodiment, the intermediate space is constructed as a spherical portion or segment and the diaphragm is circular. This embodiment allows the switchable flexibility and the decoupling diaphragm to be constructed circularly and the damping channel connecting the two chambers to be arranged radially outside of the decoupling diaphragm. The damping channel may extend helically about the bearing axis, wherein a corresponding cross section is used for a throttled flow between the two fluid-filled chambers.

The intermediate space may alternatively be constructed as a toroidal portion or segment and the diaphragm may be annular. In this embodiment, the channel connecting the fluid-filled chambers may also be arranged radially outside of the intermediate space. Additionally, a bypass may be provided in a region of the center axis of the engine bearing. The bypass may be arranged for ensuring pressure equilibrium at corresponding pressure peaks.

The action of the diaphragm as a decoupling diaphragm may be additionally enhanced in that the diaphragm is provided with at least one protuberance to ensure additional residual flexibility when the diaphragm contacts a corresponding adjacent wall defining the intermediate space. Further, a decoupling residual flexibility of the intermediate spaces between the protuberances on the diaphragm is ensured when the diaphragm contacts the corresponding adjacent wall of the intermediate space by suitable protuberances on the diaphragm.

For reasons which relate to the installation, it may be necessary to arrange the valve to extend transverse or parallel to the longitudinal axis of the bearing.

Further, the check valve function and switching function may be assumed by a solenoid valve.

In another embodiment of the present invention, the gas volume in one valve position has a permanent connection to the atmosphere.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a longitudinal sectional view of an engine bearing with an annular flexible diaphragm according to an embodiment of the present invention; and

FIG. 2 is a longitudinal sectional view of another embodiment of an engine bearing with a circular diaphragm according to the present invention.

### DETAILED DESCRIPTION OF THE PRESENTLY PREFERRED EMBODIMENTS

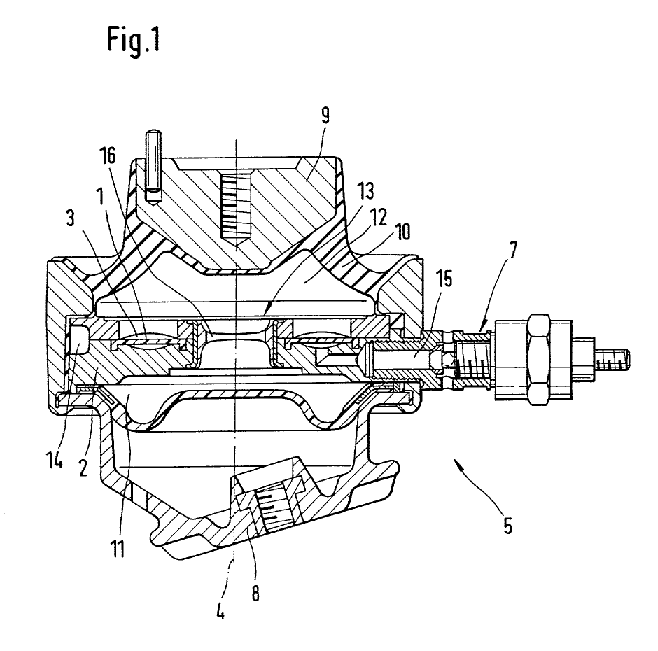

A hydraulically damping engine bearing 5 is shown in FIG. 1 according to an embodiment of the present invention and includes fastening parts 8 and 9 and a rubber-elastic circumferential wall 10. Two chambers 11 and 12 which are arranged between the fastening parts 8, 9 are filled with a damping medium and are divided by a dividing wall 13. The two chambers 11 and 12 are connected by a channel 14. A deflectable diaphragm 1 is arranged for decoupling the transfer of high-frequency oscillations with low amplitudes from one of the chambers 11, 12 to the other.

The diaphragm 1 forms an intermediate space 3 with an area 2 of the dividing wall 13 used for clamping the diaphragm 1. A flow connection 15 extends from a valve 7 to the intermediate space 3. The valve 7 includes a check valve and a switch for closing and opening the flow connection 15.

Further, the dividing wall 13 includes an additional bypass 16 in the area of a longitudinal axis 4 of the engine bearing 5. The bypass 16 opens at pressure peaks after a given overpressure.

During operation of the bearing 5, the movement of the rubber-elastic circumferential wall 10 creates a pumping action which initially effects a deaeration of the intermediate space 3 via the diaphragm 1 when the flow connection 15 is closed in that the check valve provided in the valve 7 opens at pressure peaks. This deaeration process is repeated until the intermediate space 3 is deaerated and the diaphragm 1 contacts a stop, i.e., the portion of the dividing wall 13 that defines the intermediate space 3. The switch in the valve 7 may then be opened as needed so that gas flows out of the atmosphere or a pressure accumulator through the flow connection 15 into the intermediate space 3 and the diaphragm 1 moves into the shown position.

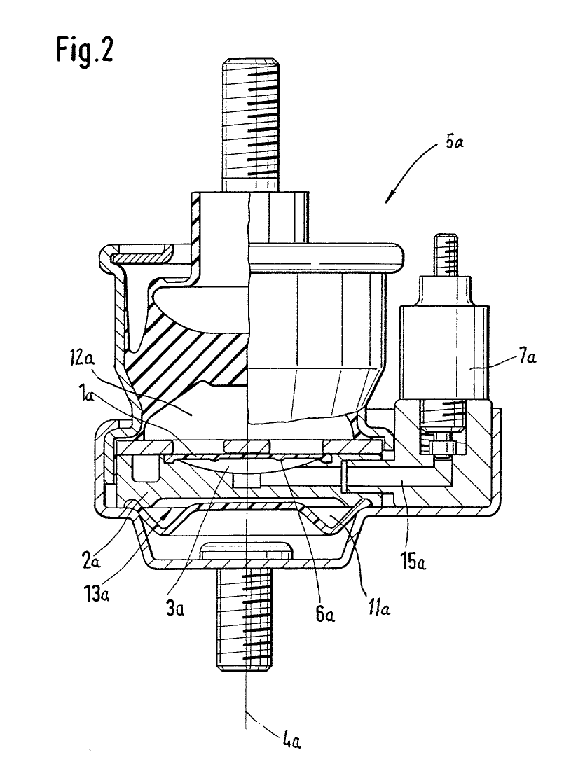

FIG. 2 shows a further embodiment of a hydraulically damping engine bearing 5a in which a dividing wall 13a divides the engine bearing 5a into two chambers 11a, 12a. The dividing wall 13a has a circular diaphragm 1a arranged thereon and a flow connection 15a opens into the area of a bearing axis 4a into an intermediate space 3a defined between the diaphragm 1a and an area 2a of the dividing wall 13a. The manner of operation of the engine bearing 5a corresponds to the operation of the engine bearing 5 of FIG. 1 described above.

The diaphragm 1a in the embodiment of FIG. 2 includes protuberances 6a on its side facing the wall of the intermediate space 3a. These protuberances 6a provide additional flexibility for decoupling high-frequency oscillations at low amplitudes when the diaphragm 1a already contacts the wall of the intermediate space 3a. Small intermediate spaces remain between the protuberances 6a even when the diaphragm 1a contacts the wall. These small intermediate spaces, the size of which depends on the arrangement of the protuberances 6a, ensure further residual flexibility of the diaphragm 1a for providing the decoupling effect.

FIG. 2 also shows that the valve 7a is depicted as a solenoid valve which performs the functions of the check valve and the switching function described above with reference to FIG. 1. Of course, the solenoid valve of FIG. 2 may also be used in the embodiment of the engine bearing 5 shown in FIG. 1.

Accordingly, the embodiments of FIGS. 1 and 2 show a diaphragm which allows the bearing characteristic of the engine bearing 5, 5a to be adjusted by changing the rigidity of the diaphragm and which works as a decoupling diaphragm. A small, compact engine bearing 5, 5a may be produced because of the horizontal arrangement of the diaphragm and because two functions are fulfilled simultaneously by the diaphragm.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A hydraulically damping engine bearing, comprising:
first and second fastening parts and an elastic wall defining two fluid-filled chambers;
a dividing wall dividing said two fluid-filled chambers and having a diaphragm deflectably arranged in one of said two fluid-filled chambers and defining an intermediate space between said diaphragm and an area of said dividing wall used for clamping said diaphragm, said dividing wall further comprising a channel connecting said two fluid-filled chambers, wherein a bearing characteristic of said engine bearing is adjustable by changing a rigidity of said diaphragm, wherein said diaphragm is operatively arranged for working against a gas volume enclosed in said intermediate space when said diaphragm has a low rigidity and resting at least partially at a stop relative to said dividing wall when said diaphragm has a high rigidity; and
a valve assembly comprising means for opening a flow connection between said intermediate space and one of the atmosphere and a pressure accumulator for aerating said intermediate space and means for deaerating said intermediate space in response to pumping movements of said elastic wall of said engine bearing, so that said intermediate space is deaeratable in response to said pumping operation of said elastic wall via said means for deaerating, and said means for deaerating being arranged proximate an outer wall of one of said first and second fastening parts and connected to said flow connection.

2. The engine bearing of claim 1, wherein said diaphragm comprises a annular shape and extends about a longitudinal axis of said engine bearing.

3. The engine bearing of claim 1, wherein said diaphragm is circular.

4. The engine bearing of claim 1, wherein said intermediate space comprises a spherical segment and said diaphragm is circular.

5. The engine bearing of claim 1, wherein said intermediate space comprises a toroidal segment and said diaphragm is annular.

6. The engine bearing of claim 1, wherein said diaphragm comprises at least one protuberance facing said dividing wall, so that said diaphragm has residual elastic flexibility when said diaphragm contacts the portion of said dividing wall which defines the intermediate space.

7. The engine bearing of claim 1, wherein said valve extends transverse to said longitudinal axis of said engine bearing.

8. The engine bearing of claim 1, further comprising a solenoid valve including said means for opening a flow connection and said means for deaerating.

9. The engine bearing of claim 1, where said gas volume in said intermediate space is connected to said atmosphere in one position of said valve assembly.

10. The engine bearing of claim 1, wherein said means for opening said flow connection comprises a switch and said means for deaerating comprises a check valve.
